(19) United States
(12) Patent Application Publication
(10) Pub. No.: US 2025/0146413 A1
(43) Pub. Date: May 8, 2025

(54) METHOD AND SYSTEM FOR MONITORING COAL SHEARER STATUS BASED ON DIGITAL TWINNING, AND ELECTRONIC DEVICE

(71) Applicant: Taiyuan University of Technology, Taiyuan City (CN)

(72) Inventors: Hua Ding, Taiyuan City (CN); Ruijia Zhang, Taiyuan City (CN); Yudong Wang, Taiyuan City (CN); Ning Li, Taiyuan City (CN); Xiaochun Sun, Taiyuan City (CN); Guang Wang, Taiyuan City (CN); Weizhuo Zhao, Taiyuan City (CN); Ziyue Ma, Taiyuan City (CN); Guoshu Pu, Taiyuan City (CN); Hanchi Chu, Taiyuan City (CN)

(21) Appl. No.: 18/425,247

(22) Filed: Jan. 29, 2024

(30) Foreign Application Priority Data
Nov. 3, 2023 (CN) 2023114559833

(51) Int. Cl. E21C 35/00; E21C 27/02; G06F 30/20

(52) U.S. Cl. CPC E21C 35/302; G06F 30/20; E21C 27/02; E21C 2100/00

(57) ABSTRACT

The present disclosure provides a method and system for monitoring a coal shearer status based on digital twinning, and an electronic device, and relates to the technical field of real-time status monitoring. The method includes: obtaining physical parameters, real-time driving data, and real-time status data of a coal shearer physical entity, where the physical parameters include geometric parameters, material properties, and positional parameters; the real-time driving data includes a real-time position, a real-time speed, and a real-time angle of a rocker arm; and the real-time status data includes real-time vibration information; building a coal shearer digital twin model on a Unity3D engine according to the physical parameters of the coal shearer physical entity; and updating a status of the coal shearer digital twin model based on the real-time driving data and the real-time status data. The present disclosure achieves visual monitoring of a coal shearer status.

### CROSS REFERENCE TO RELATED APPLICATION

This patent application claims the benefit and priority of Chinese Patent Application No. 2023114559833, filed with the China National Intellectual Property Administration on Nov. 3, 2023, the disclosure of which is incorporated by reference herein in its entirety as part of the present application.

### TECHNICAL FIELD

The present disclosure relates to the technical field of real-time status monitoring, and in particular, to a method and system for monitoring a coal shearer status based on digital twinning, and an electronic device.

### BACKGROUND

Coal shearers are the core equipment of the fully mechanized mining face and serve for coal seam cutting. The working efficiency of the coal shearers directly affects the efficiency and economic returns of coal mining. However, due to the complex internal structure of the coal shearer as well as other adverse factors such as working environment statistics, the coal shearers have frequent failures. These failures often cause serious financial losses and may even jeopardize the lives of the mineworkers. In addition, the current methods for monitoring a coal shearer status mainly rely on expert systems, physical model simulations, deep learning algorithms, and other determining based on limited data analysis. However, these methods cannot accurately map the physical statuses of the devices to the information space, and cannot predict the health statuses of the devices in real time or present the postures of the devices in a visual way. This leads to problems of limited analysis results, inaccuracy, and low efficiency, making it difficult to effectively guide the implementation of predictive maintenance policies.

### SUMMARY

An objective of the present disclosure is to provide a method and system for monitoring a coal shearer status based on digital twinning, and an electronic device. A physical status of a coal shearer is accurately mapped to a virtual information space, thereby achieving the visual presentation of a posture of the physical entity and achieving visual monitoring of a coal shearer status.

To achieve the above objective, the present disclosure provides the following technical solutions.

A method for monitoring a coal shearer status based on digital twinning includes:
obtaining physical parameters, real-time driving data, and real-time status data of a coal shearer physical entity, where the physical parameters include geometric parameters, material properties, and positional parameters; the geometric parameters include a length, a height, a width, and a hole depth of a mechanical equipment, the material properties include a material type, a stiffness, a strength, and an elastic modulus, and the positional parameters include a moving distance, a tilt angle, a rotation angle, and a height; the real-time driving data includes a real-time position, a real-time speed, and a real-time angle of a rocker arm; and the real-time status data includes real-time vibration information;
building a coal shearer digital twin model on a Unity3D engine according to the physical parameters of the coal shearer physical entity; and
updating a status of the coal shearer digital twin model based on the real-time driving data and the real-time status data.

Alternatively, the method further includes:
inputting the real-time driving data and the real-time status data of the coal shearer physical entity to a remaining life prediction model to obtain a remaining life of the coal shearer physical entity, where the remaining life prediction model is obtained by training a deep neural network model based on multiple sets of sample data, the deep neural network model includes a deep convolutional neural network (DCNN), an auto-encoder (AE), and a bidirectional gated recurrent unit (bi-GRU), and the sample data includes historical driving data and historical status data of coal shearer physical entities for training and corresponding actual remaining lives.

Optionally, the building a coal shearer digital twin model on a Unity3D engine according to the physical parameters of the coal shearer physical entity includes:
generating the coal shearer digital twin model based on the physical parameters of the coal shearer physical entity and a movement relationship between components of the coal shearer physical entity by using a three-dimensional modeling technology and a Unity3D engine rendering technology.

Optionally, the real-time driving data and the real-time status data are obtained by using multiple sensors disposed on the coal shearer physical entity. Each of the sensors includes a position encoder, an angular velocity sensor, and a vibration sensor.

The position encoder is configured to obtain the real-time position and the real-time speed. The angular velocity sensor is configured to obtain the real-time angle of the rocker arm. The vibration sensor is configured to obtain the real-time vibration information.

Optionally, before the updating a status of the coal shearer digital twin model based on the real-time driving data and the real-time status data, the method further includes:
sending the real-time driving data and the real-time status data to the Unity3D engine through RS-485 serial communication and a Modbus RTU communication protocol.

A system for monitoring a coal shearer status based on digital twinning includes:
a data acquisition module, configured to obtain physical parameters, real-time driving data, and real-time status data of a coal shearer physical entity, where the physical parameters include geometric parameters, material properties, and positional parameters; the geometric parameters include a length, a height, a width, and a hole depth of a mechanical equipment, the material properties include a material type, a stiffness, a strength, and an elastic modulus, and the positional parameters include a moving distance, a tilt angle, a rotation angle, and a height; the real-time driving data includes a real-time position, a real-time speed, and a real-time angle of a rocker arm; and the real-time status data includes real-time vibration information;
a model building module, configured to build a coal shearer digital twin model on a Unity3D engine according to the physical parameters of the coal shearer physical entity; and
a visualization module, configured to update a status of the coal shearer digital twin model based on the real-time driving data and the real-time status data.

An electronic device includes a memory and a processor. The memory is configured to store a computer program. The processor runs the computer program to cause the electronic device to implement the foregoing method for monitoring a coal shearer status based on digital twinning.

Optionally, the memory is a readable storage medium.

According to the specific embodiments provided in the present disclosure, the present disclosure has the following technical effects:

The present disclosure provides a method and system for monitoring a coal shearer status based on digital twinning, and an electronic device. First, physical parameters, real-time driving data, and real-time status data of a coal shearer physical entity are obtained. Then, a coal shearer digital twin model is built on a Unity3D engine according to the physical parameters of the coal shearer physical entity. Finally, a status of the coal shearer digital twin model is updated based on the real-time driving data and the real-time status data. The present disclosure can accurately map a physical status of a coal shearer to a virtual information space by means of the internal components, internal libraries, and C#programming of the Unity3D engine, thereby achieving the visual presentation of a posture of the coal shearer physical entity and achieving visual monitoring of a coal shearer status.

### BRIEF DESCRIPTION OF THE DRAWINGS

To describe the technical solutions in embodiments of the present disclosure or in the prior art more clearly, the accompanying drawings required in the embodiments are briefly described below. Apparently, the accompanying drawings in the following description show merely some embodiments of the present disclosure, and other drawings can be derived from these accompanying drawings by those of ordinary skill in the art without creative efforts.

FIG. 1 is a schematic flowchart of a method for monitoring a coal shearer status based on digital twinning according to Embodiment 1 of the present disclosure;

FIG. 2 is a flowchart of a specific implementation method for monitoring a coal shearer status in real time based on digital twinning;

FIG. 3 shows a model of a coal shearer physical entity;

FIG. 4 is a diagram of a coal shearer digital twin model;

FIG. 5 is a diagram of mounted sensors of a coal shearer physical entity;

FIG. 6 is a diagram of a data information collection interface of a host computer Modbus RTU communication library written in C#;

FIG. 7 is an outline diagram of a technology for real-time mapping of a coal shearer driven by Unity3D based on a digital twin platform; and

FIG. 8 is a framework diagram of calling Python scripts through command lines in C#.

### DETAILED DESCRIPTION OF THE EMBODIMENTS

The technical solutions of the embodiments of the present disclosure are clearly and completely described below with reference to the drawings in the embodiments of the present disclosure. Apparently, the described embodiments are merely a part rather than all of the embodiments of the present disclosure. All other embodiments obtained by those skilled in the art based on the embodiments of the present disclosure without creative efforts shall fall within the protection scope of the present disclosure.

Before the description of the embodiments of the present disclosure, a Unity3D engine is described: The Unity3D engine has a mature visual user interface, a powerful physics engine system, and a built-in integrated library. Developers can use a large number of scripts to implement scenarios and specific logic and functions by dragging and creating state machines or in other manners. If needed, the developers can also write their own scripts or modify existing plug-ins to meet specific requirements. Most importantly, Unity3D not only has a fast and mature development model, but also supports full platform compatibility. Developed projects can easily run on different platforms, and usually can be equipped on multiple platforms such as Android, Mac, and Web with only a small number of code changes required.

An objective of the present disclosure is to provide a method and system for monitoring a coal shearer status based on digital twinning, and an electronic device, so as to achieve visual monitoring of a coal shearer status.

In order to make the above objective, features and advantages of the present disclosure clearer and more comprehensible, the present disclosure will be further described in detail below in combination with accompanying drawings and particular implementation modes.

### Embodiment 1

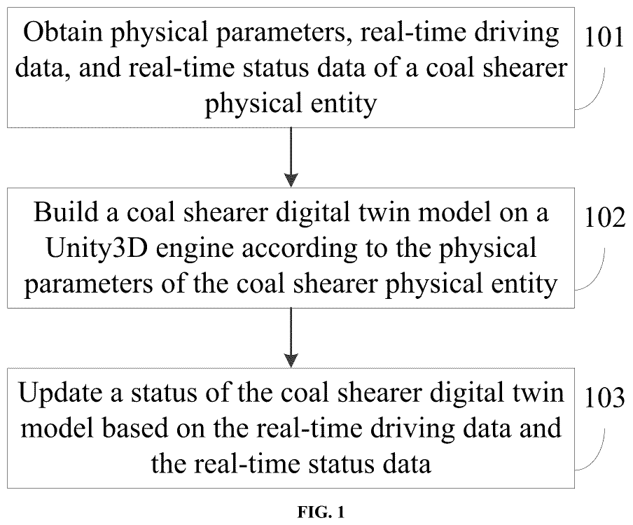

FIG. 1 is a schematic flowchart of a method for monitoring a coal shearer status based on digital twinning according to Embodiment 1 of the present disclosure. As shown in FIG. 1, in this embodiment, the method for monitoring a coal shearer status based on digital twinning includes the following steps.

Step 101: Obtain physical parameters, real-time driving data, and real-time status data of a coal shearer physical entity.

The physical parameters include geometric parameters, material properties, and positional parameters. The geometric parameters include a length, a height, a width, and a hole depth of a mechanical equipment. The material properties include a material type, a stiffness, a strength, and an elastic modulus. The positional parameters include a moving distance, a tilt angle, a rotation angle, and a height. The real-time driving data includes a real-time position, a real-time speed, and a real-time angle of a rocker arm. The real-time status data includes real-time vibration information.

In an optional implementation, the real-time driving data and the real-time status data are obtained by using multiple sensors disposed on the coal shearer physical entity. Each of the sensors includes a position encoder, an angular velocity sensor, and a vibration sensor.

The position encoder is configured to obtain the real-time position and the real-time speed. The angular velocity sensor is configured to obtain the real-time angle of the rocker arm. The vibration sensor is configured to obtain the real-time vibration information.

Specifically, the position encoder is mounted at an end of a high speed shaft inside a traction transmission box of the coal shearer physical entity. Through the connection to the high speed shaft, the rotation of the high speed shaft is measured to provide the real-time position and the real-time speed. The real-time speed can also be collected by disposing the position encoder on the rocker arm of the coal shearer physical entity. The angular velocity sensor and the vibration sensor are disposed on the rocker arm of the coal shearer physical entity. The real-time vibration information includes a noise signal, a vibration signal, and a load signal.

Step 102: Build a coal shearer digital twin model on a Unity3D engine according to the physical parameters of the coal shearer physical entity.

Specifically, in the Unity3D engine, an appropriate hierarchical structure is established according to a motion mode of a coal shearer to establish a parent-child relationship between all components.

In an optional implementation, step 102 includes:

generating the coal shearer digital twin model based on the physical parameters of the coal shearer physical entity and a movement relationship between components of the coal shearer physical entity by using a three-dimensional modeling technology and a Unity3D engine rendering technology.

Step 103: Update a status of the coal shearer digital twin model based on the real-time driving data and the real-time status data.

Specifically, the status of the coal shearer digital twin model in the Unity3D engine is continuously updated by using the received real-time driving data and real-time status data, to complete online data-driven high-fidelity behavioral simulation of the coal shearer, thereby achieving real-time mapping and visualization of the coal shearer in a physical space and an information space. Step 103 specifically includes:
a. A hyper-realistic simulation environment is built based on real environment parameters (a temperature and humidity of a working environment) of the coal shearer physical entity. For example, a coal seam simulation environment is created in the Unity3D engine. A virtual coal seam model is established through randomly generated Perlin noise vertex data and a Mesh grid generation technology. In addition, a Mesh Collider component is added to the virtual coal seam to achieve physical interaction with coal mine equipment.
b. A connection between the physical entity and a digital twin model is called in the Unity3D engine by using a function “Update( ), and a coal shearer data twin model in the Unity3D engine is updated according to the real-time status data, to achieve visualization of the real-time posture of the physical entity.

In an optional implementation, before step 103, the method further includes:
sending the real-time driving data and the real-time status data to the Unity3D engine through RS-485 serial communication and a Modbus RTU communication protocol.

Specifically, the transmission of the real-time driving data and the real-time status data mainly includes two steps regarding a communication protocol and a Modbus RTU communication library. The communication protocol is used to transmit the real-time driving data and the real-time status data collected from the coal shearer physical entity. The Modbus RTU communication library is used to receive the real-time driving data and the real-time status data. The data transmission includes:
a. After the sensors mounted on the coal shearer physical entity collects the real-time driving data and the real-time status data, through a series of data processing by single-chip microcomputers, key operating data of the coal shearer, such as a movement speed, a position, left and right rocker arm angles, and body tilt angles of the coal shearer are obtained.
b. The RS-485 serial communication and the Modbus RTU communication protocol are used together to implement the data transmission. RS-485 is a powerful serial communication standard, applicable to data transmission needs over long distances and multi-point connections, and also supports different communication rates, usually ranging from 2400 bps to 10 Mbps. The Modbus protocol defines communication details such as a data frame structure, register mapping, and a function code, such that different devices can understand and interpret each other's data.
c. A host computer Modbus RTU communication library written in C#relies on methods and properties of a SerialPort class, a serial port can be open and closed, and a Baud rate and other serial port properties can also be configured. The communication library is used to receive real-time entity data collected by the transmission through the Modbus communication protocol. Then, C#programming scripts are used to transmit the data into a database.
d. Data exchange between the database and Unity3D is performed by using an API and C#scripts in the Unity3D engine. A Web API is written in C#, and the API is responsible for obtaining the data from the database and transmitting the data to the Unity3D engine through HTTP requests for application.

In an optional implementation, the method for monitoring a coal shearer status based on digital twinning further includes:
inputting the real-time driving data and the real-time status data of the coal shearer physical entity to a remaining life prediction model to obtain a remaining life of the coal shearer physical entity. The remaining life prediction model is obtained by training a deep neural network model based on multiple sets of sample data. The deep neural network model includes a DCNN, an AE, and a bi-GRU. The sample data includes historical driving data and historical status data of coal shearer physical entities for training and corresponding actual remaining lives.

Specifically, the remaining life prediction model is implemented by using the Python programming language. The C#script calls the Python code through command lines. A process calling method is used to directly call a Python interpreter in C#code to interpret and execute a corresponding Python code file. Through redirection of standard input and output or in a form of an external file, the C#code is caused to obtain a Python script running result.

A Line Chart component in a plug-in XCharts of the Unity3D engine is used to set parameters such as labels, maximum values, and minimum values of an X-axis and a Y-axis in an Inspector panel to adapt to learning curve data. A C#script is created and attached to the Line Chart. In the script, code is written to transmit the learning curve data to the Line Chart component to update the chart, and an API of XCharts is used to add threshold data Serie and display an evaluation result of the life prediction model.

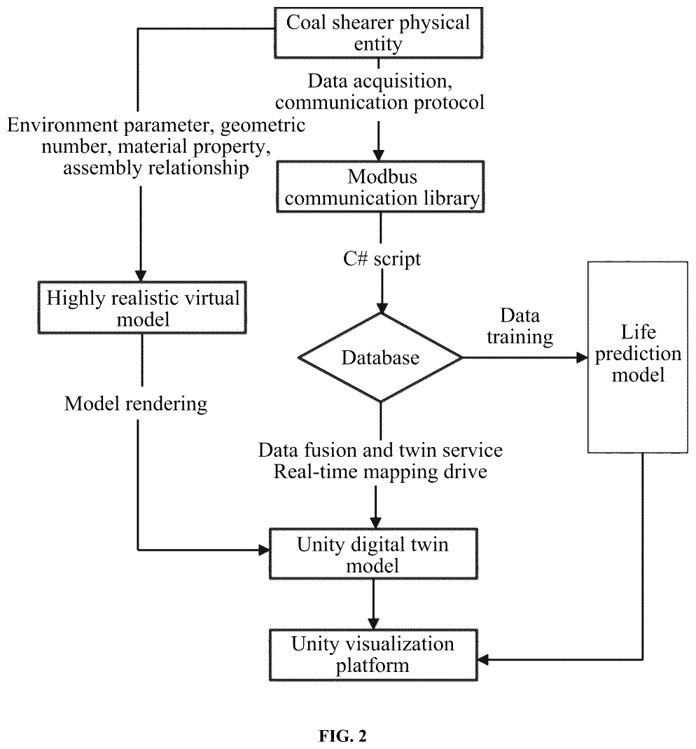

Further, as shown in FIG. 2, the present disclosure further provides a specific implementation method for monitoring a coal shearer status in real time based on digital twinning. First, multiple types of sensors are configured to collect real-time operation data (that is, real-time driving data and real-time status data) of a coal shearer, the data is transmitted through a communication protocol, and a Modbus RTU communication library is used on a host computer to receive the data. Then, the received data is divided into two parts. One part is used to build a digital twin of the coal shearer and a hyper-realistic simulation environment to achieve real-time visualization of a posture of the coal shearer. The other part is used to build a deep learning model and implement intelligent monitoring of statuses of key components and parts of the coal shearer. Finally, through a deep learning prediction result and fusion prediction of behavioral simulation of the digital twin, comprehensive, real objective, and real-time mapping of the physical world can be achieved. In this way, a diagnosis result that is more accurate than that of a conventional diagnosis method can be obtained, thereby comprehensively improving the degree of intelligence of fault diagnosis of the mechanized mining equipment.

A specific process of the specific implementation method for monitoring a coal shearer status in real time based on digital twinning is as follows:

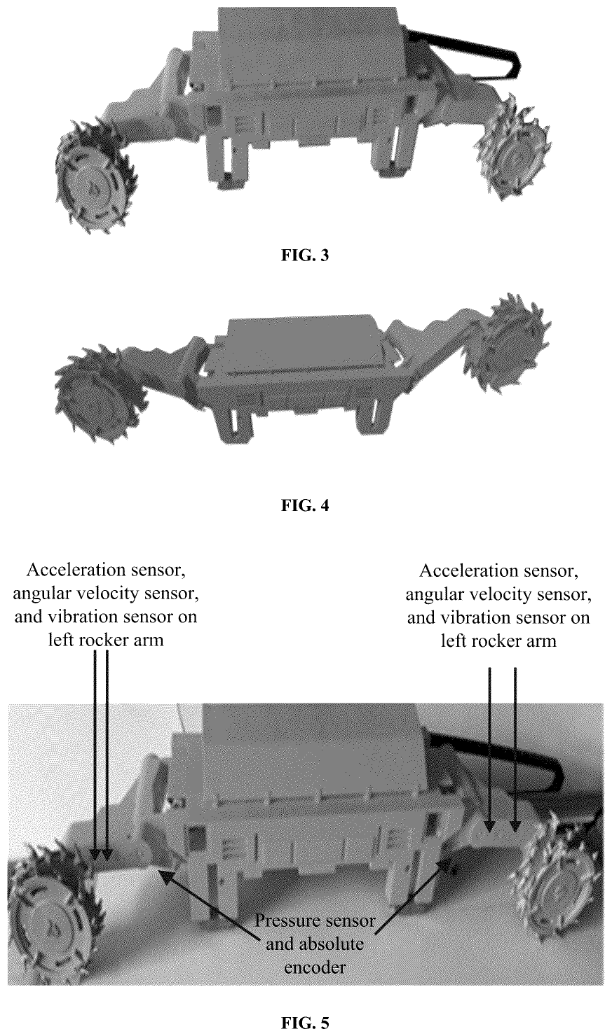

(1) As shown in FIG. 3 and FIG. 4, a virtual model of each component of the coal shearer is established in software Solidworks based on a built physical entity model of the coal shearer by using a three-dimensional modeling technology. Main components include a coal shearer body model, a rocker model, and a roller model. Lightweight processing is performed on the component models of the virtual models. A coal shearer virtual model is established in SolidWorks based on a movement relationship between the components of the coal shearer physical entity.

The model is converted between SolidWorks and Unity3D. The coal shearer virtual model in SolidWorks is exported in a STEP format. The model is converted to an FBX format and imported into Unity3D by using 3ds MAX.

In the Unity3D engine, a parent-child relationship of the virtual models is established according to movement rules of the physical entity. Herein, joint components (fixed joints, character joints, and hinge joints) are used to establish an appropriate hierarchical structure for the virtual model. In addition, C#scripts are written to implement execution actions of the virtual device to turn it into a dynamic digital twin model of the coal shearer, thereby ensuring that the evolution process of the entity is consistent with that of the twin model.

(2) As shown in FIG. 5, various sensors are mounted on the coal shearer physical entity to collect data. The sensors are to be mounted at the following positions:

A speed sensor and an angular velocity sensor are located on a rocker arm of the physical entity. The angular velocity sensor is configured to collect a tilt angle or swing data of a component. An acceleration sensor is configured to collect height and posture data of the coal shearer. In addition, a vibration sensor is mounted on the rocker arm and configured to collect real-time vibration information. A position encoder is mounted at an end of a high speed shaft inside a traction transmission box. Through the connection to the high speed shaft, the rotation of the high speed shaft is measured to provide a real-time position and a real-time speed.

An STM32 single-chip microcomputer reads the data captured by the sensor mounted on the rocker arm. Through the combination of data fusion and filtering technologies, a roll, a pitch, and a yaw of the rocker arm of the coal shearer can be calculated, thereby calculating real-time data of the rocker arm angle.

An absolute encoder is mounted to infer real-time data information of a speed of the physical model by measuring position changes of an object over a period of time. The encoder records a unique code value of the object, for identifying a specific position. Over time, a movement distance of the object can be accurately calculated according to changes in the code values, and then the speed of the object can be determined.

(3) The RS-485 serial communication and the Modbus RTU communication protocol are used together to implement the data transmission. Specific operation steps are as follows.

The sensor device and the STM32 single-chip microcomputer are connected to the RS-485 bus, and physical layer settings of the RS-485 bus are configured, including a voltage level, a terminal resistance, and the like. It is ensured that all the devices are correctly configured such that they can communicate on the same bus.

The Modbus RTU communication protocol is set. Modbus RTU is a serial communication protocol that uses binary encoding to represent data and each byte consists of eight bits.

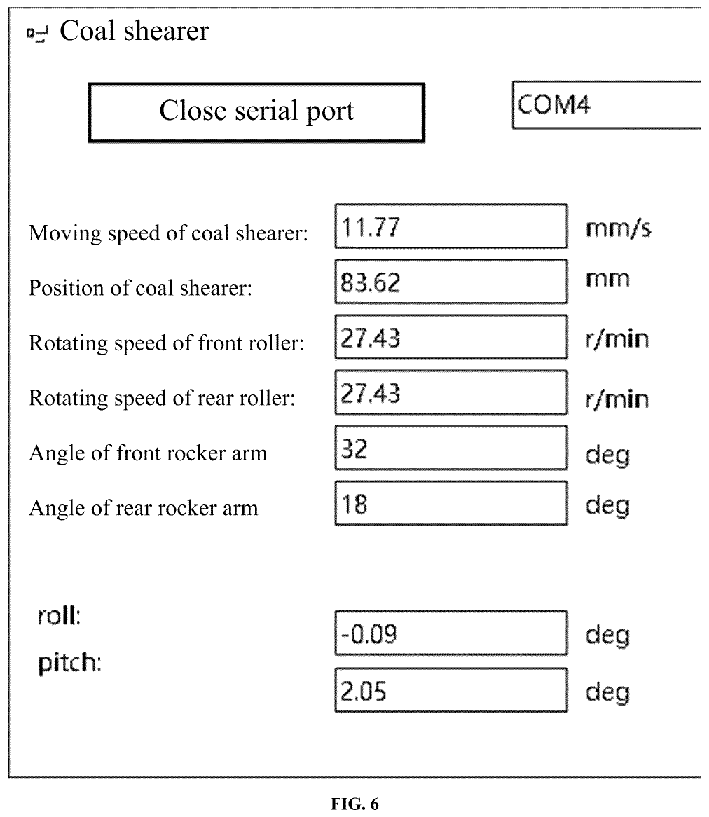

As shown in FIG. 6, the development environment for writing a host computer Modbus RTU communication library in C#is visual Studio 2022, and the type is C#Windows Forms program. A data information collection interface is designed by creating winForms.

The host computer Modbus RTU communication library written in C#mainly includes the need to set serial port connections, Baud rates, data bits, stop bits, and parity check bits. The code for the communication library is written as follows:

In the communication class, an instruction System.IO.Ports.SerialPort class is used to set and manage the serial port connections. System.IO.Ports is a serial communication namespace of C#and is part of the .NETframe framework, and provides serial port execution and hardware device communication functions.

An instruction System. Collections. Generic is used, and the meaning of the instruction is to use collections and data structures in the .NET framework.

The communication library is used to receive real-time entity data collected by the transmission through the Modbus communication protocol. Then C#programming is used to transmit the data to a database, and an INSERT statement is used to insert the data into a database table.

Data exchange between the database and the Unity3D engine is performed by using an API and C#scripts in the Unity3D engine.

The Visual Studio integrated development environment is used to create a C#script in the Unity3D engine. This script writes code to establish a connection to the database. Instructions FileStream and StreamReader are used to open the database, file content is read line by line, and each line of data is converted into a floating point number and added to dataList. In addition, an instruction “List<float>dataList=new List<float> ( )” is written. DataList [ ] represents the received data of each component of the physical entity.

(4) Steps of building a Unity3D digital twin visualization platform are as follows:

A hyper-realistic simulation environment is built based on real environment parameters (a temperature and humidity of a working environment). For example, a coal seam simulation environment is created in Unity. A virtual coal seam model is established through randomly generated Perlin noise vertex data and a Mesh grid generation technology. In addition, a Mesh Collider component is added to the virtual coal seam to achieve physical interaction with coal mine equipment.

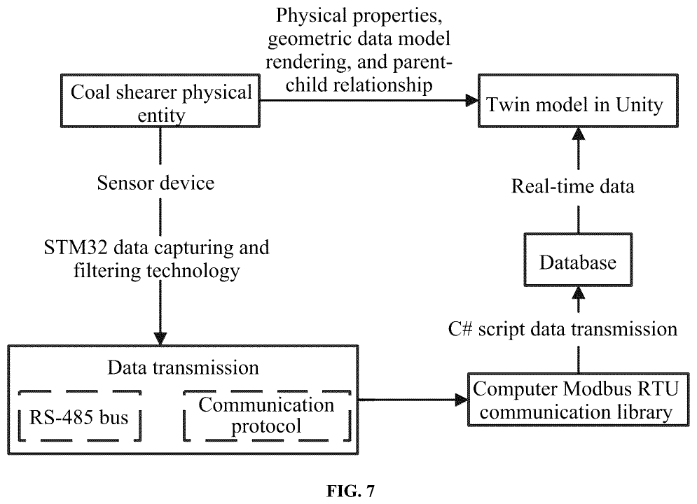

As shown in FIG. 7, a procedure in which the physical entity model drives in real time the digital twin model to move is implemented in Unity. A basic class MonoBehaviour in Unity is used to create a C#script. Specific steps for C#script programming are as follows:

First, public variables are declared, and the variables may be set in a Unity editor. For example, m_Body is a Transform type variable used to represent an object of the twin model body. Similarly, other variables are also declared to represent other mechanical component elements in the twin model.

Second, a Unity life cycle method, that is, an “Update( ) method, is used to update a status of the coal shearer digital twin model, and each frame thereof is to be called. A real-time linkage effect with the physical entity is achieved. A formula for updating the status of the twin model in real time is as follows:
transform. Rotate (Vector3.up*datalist[ ] *Time.deltaTime)

Vector3.up represents a movement direction of each component of the twin model, dataList[ ] represents the received data of each component of the physical entity, and Time.deltaTime represents a time interval.

Based on (1) to (4) above, the real-time data of the coal shearer physical entity during working can be collected and analyzed, and a real-time working posture thereof can also be presented for visualization.

(5) A remaining life prediction model is built, fast Fourier transform (FFT) is used to perform time-frequency conversion on data information, and time domain and frequency domain features are selected. A deep neural network model combining a DCNN model, an AE, and a bi-GRU is built for analysis and prediction of a remaining life to fully use prediction features and prediction capabilities of each model.

(6) Digital twinning is integrated with a deep learning algorithm. In the present disclosure, the service life prediction model is integrated into the Unity3D engine through the interaction between Python and the Unity3D engine, and a Python script is called through command lines. Specific operations are as follows:

The remaining life prediction model is implemented by using a Python programming language. A Python environment is set, and a subprocess module of Python is used to execute a Python script.

A C#script is used to execute the Python script in Unity, and a Process class in a System. Diagnostics namespace is used to run the Python script.

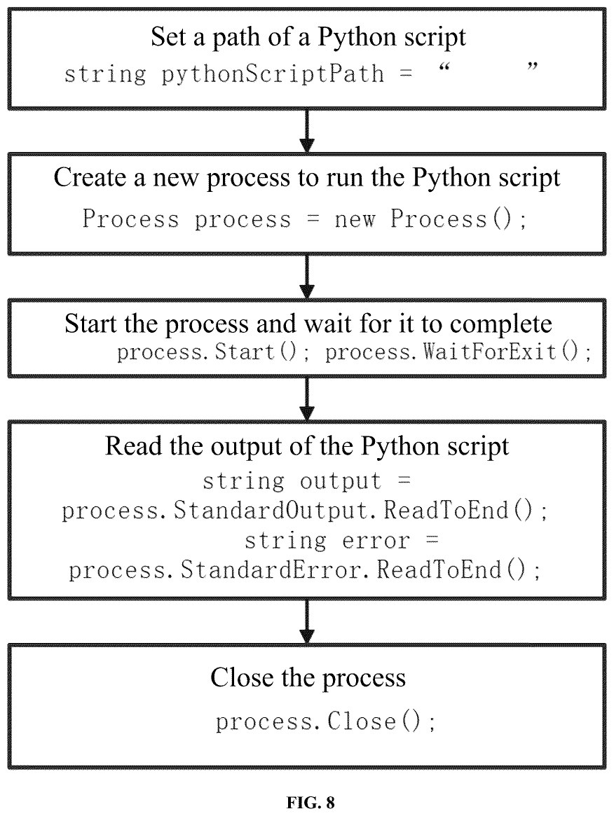

A process calling method is used to directly call a Python interpreter in C#code to interpret and execute a corresponding Python code file. Through redirection of standard input and output or in a form of an external file, the C#code is caused to obtain a Python script running result. As shown in FIG. 8, a Process class process calling method in the C#language is used to drive a deep learning service life prediction model written in the Python language to run.

A Line Chart component in a plug-in XCharts of the Unity3D is used to set parameters such as labels, maximum values, and minimum values of an X-axis and a Y-axis in an Inspector panel to adapt to learning curve data. A C#script is created and attached to the Line Chart. In the script, code is written to transmit the learning curve data to the Line Chart component to update the chart, and an API of XCharts is used to add threshold data Serie and display an evaluation result of the life prediction model. Calling statements of relevant controls are used to complete graphical and digital display of a remaining life of a component.

Based on (5) and (6) above, the service life prediction model can be integrated into the Unity3D engine to achieve the integration of the service life prediction model and digital twinning.

### Embodiment 2

In this embodiment, a system for monitoring a coal shearer status based on digital twinning includes:
a data acquisition module, configured to obtain physical parameters, real-time driving data, and real-time status data of a coal shearer physical entity, where the physical parameters include geometric parameters, material properties, and positional parameters; the geometric parameters include a length, a height, a width, and a hole depth of a mechanical equipment, the material properties include a material type, a stiffness, a strength, and an elastic modulus, and the positional parameters include a moving distance, a tilt angle, a rotation angle, and a height; the real-time driving data includes a real-time position, a real-time speed, and a real-time angle of a rocker arm; and the real-time status data includes real-time vibration information;
a model building module, configured to build a coal shearer digital twin model on a Unity3D engine according to the physical parameters of the coal shearer physical entity; and
a visualization module, configured to update a status of the coal shearer digital twin model based on the real-time driving data and the real-time status data.

### Embodiment 3

An electronic device includes a memory and a processor. The memory is configured to store a computer program. The processor runs the computer program to cause the electronic device to implement the method for monitoring a coal shearer status based on digital twinning in Embodiment 1.

In an optional implementation, the memory is a readable storage medium.

In the present disclosure, a health status of the coal shearer is monitored by using a three-dimensional modeling technology, a communication technology, a digital twinning technology, and a deep learning algorithm. In the Unity3D engine, the digital twinning technology is used to complete online data-driven high-fidelity behavioral simulation of the coal shearer, and a current status of the physical entity model is mapped to a digital space in real time, to achieve visualization of a real-time status of the coal shearer, thereby providing a qualitative analysis basis for the prediction of the health status of the coal shearer. The deep learning model is integrated into the Unity3D engine to achieve the online data-driven prediction of remaining lives of key components and parts of the coal shearer, thereby providing a quantitative analysis basis for the monitoring of the health status of the coal shearer.

Each embodiment in the description is described in a progressive mode, each embodiment focuses on differences from other embodiments, and references can be made to each other for the same and similar parts between embodiments. Since the system disclosed in an embodiment corresponds to the method disclosed in an embodiment, the description is relatively simple, and for related contents, references can be made to the description of the method.

Particular examples are used herein for illustration of principles and implementation modes of the present disclosure. The descriptions of the above embodiments are merely used for assisting in understanding the method of the present disclosure and its core ideas. In addition, those of ordinary skill in the art can make various modifications in terms of particular implementation modes and the scope of application in accordance with the ideas of the present disclosure. In conclusion, the content of the description shall not be construed as limitations to the present disclosure.

What is claimed is:

1. A method for monitoring a coal shearer status based on digital twinning, wherein the method comprises:
obtaining physical parameters, real-time driving data, and real-time status data of a coal shearer physical entity, wherein the physical parameters comprise geometric parameters, material properties, and positional parameters; the geometric parameters comprise a length, a height, a width, and a hole depth of a mechanical equipment, the material properties comprise a material type, a stiffness, a strength, and an elastic modulus, and the positional parameters comprise a moving distance, a tilt angle, a rotation angle, and a height; the real-time driving data comprises a real-time position, a real-time speed, and a real-time angle of a rocker arm; and the real-time status data comprises real-time vibration information;
building a coal shearer digital twin model on a Unity3D engine according to the physical parameters of the coal shearer physical entity; and
updating a status of the coal shearer digital twin model based on the real-time driving data and the real-time status data.

2. The method for monitoring a coal shearer status based on digital twinning according to claim 1, wherein the method further comprises:
inputting the real-time driving data and the real-time status data of the coal shearer physical entity to a remaining life prediction model to obtain a remaining life of the coal shearer physical entity, wherein the remaining life prediction model is obtained by training a deep neural network model based on multiple sets of sample data, the deep neural network model comprises a deep convolutional neural network (DCNN), an auto-encoder (AE), and a bidirectional gated recurrent unit (bi-GRU), and the sample data comprises historical driving data and historical status data of coal shearer physical entities for training and corresponding actual remaining lives.

3. The method for monitoring a coal shearer status based on digital twinning according to claim 1, wherein the building a coal shearer digital twin model on a Unity3D engine according to the physical parameters of the coal shearer physical entity comprises:
generating the coal shearer digital twin model based on the physical parameters of the coal shearer physical entity and a movement relationship between components of the coal shearer physical entity by using a three-dimensional modeling technology and a Unity3D engine rendering technology.

4. The method for monitoring a coal shearer status based on digital twinning according to claim 1, wherein the real-time driving data and the real-time status data are obtained by using multiple sensors disposed on the coal shearer physical entity, and each of the sensors comprises a position encoder, an angular velocity sensor, and a vibration sensor; and
the position encoder is configured to obtain the real-time position and the real-time speed, the angular velocity sensor is configured to obtain the real-time angle of the rocker arm, and the vibration sensor is configured to obtain the real-time vibration information.

5. The method for monitoring a coal shearer status based on digital twinning according to claim 1, wherein before the updating a status of the coal shearer digital twin model based on the real-time driving data and the real-time status data, the method further comprises:
sending the real-time driving data and the real-time status data to the Unity3D engine through RS-485 serial communication and a Modbus RTU communication protocol.

6. A system for monitoring a coal shearer status based on digital twinning, wherein the system comprises:
a data acquisition module, configured to obtain physical parameters, real-time driving data, and real-time status data of a coal shearer physical entity, wherein the physical parameters comprise geometric parameters, material properties, and positional parameters; the geometric parameters comprise a length, a height, a width, and a hole depth of a mechanical equipment, the material properties comprise a material type, a stiffness, a strength, and an elastic modulus, and the positional parameters comprise a moving distance, a tilt angle, a rotation angle, and a height; the real-time driving data comprises a real-time position, a real-time speed, and a real-time angle of a rocker arm; and the real-time status data comprises real-time vibration information;
a model building module, configured to build a coal shearer digital twin model on a Unity3D engine according to the physical parameters of the coal shearer physical entity; and
a visualization module, configured to update a status of the coal shearer digital twin model based on the real-time driving data and the real-time status data.

7. An electronic device, comprising a memory and a processor, wherein the memory is configured to store a computer program, and the processor runs the computer program to cause the electronic device to implement the method for monitoring a coal shearer status based on digital twinning according to claim 1.

8. An electronic device, comprising a memory and a processor, wherein the memory is configured to store a computer program, and the processor runs the computer program to cause the electronic device to implement the method for monitoring a coal shearer status based on digital twinning according to claim 2.

9. An electronic device, comprising a memory and a processor, wherein the memory is configured to store a computer program, and the processor runs the computer program to cause the electronic device to implement the method for monitoring a coal shearer status based on digital twinning according to claim 3.

10. An electronic device, comprising a memory and a processor, wherein the memory is configured to store a computer program, and the processor runs the computer program to cause the electronic device to implement the method for monitoring a coal shearer status based on digital twinning according to claim 4.

11. An electronic device, comprising a memory and a processor, wherein the memory is configured to store a computer program, and the processor runs the computer program to cause the electronic device to implement the method for monitoring a coal shearer status based on digital twinning according to claim 5.

12. The electronic device according to claim 7, wherein the memory is a readable storage medium.

13. The electronic device according to claim 8, wherein the memory is a readable storage medium.

14. The electronic device according to claim 9, wherein the memory is a readable storage medium.

15. The electronic device according to claim 10, wherein the memory is a readable storage medium.

16. The electronic device according to claim 11, wherein the memory is a readable storage medium.
